(19) United States
(12) Patent Application Publication
(10) Pub. No.: US 2016/0134213 A1
(43) Pub. Date: May 12, 2016

(54) ESTIMATION SYSTEM FOR ROTOR INFORMATION

(71) Applicant: Hyundai Mobis Co., Ltd., Seoul (KR)

(72) Inventor: Goo Jong JEONG, Yongin-si (KR)

(21) Appl. No.: 14/698,203

(22) Filed: Apr. 28, 2015

(30) Foreign Application Priority Data
Nov. 12, 2014 (KR) 10-2014-0157156

(51) Int. Cl. H02P 6/16; G01D 5/20

(52) U.S. Cl. CPC H02P 6/16; G01D 5/2006

(57) ABSTRACT

Disclosed is a rotor information estimation system including a resolver configured to measure a rotor location of a motor; a proportional-integral observer based on the motor and configured to estimate the rotor location of the motor; and an error calculator configured to calculate an error of the rotor location measured by the resolver using the rotor location estimated by the proportional-integral observer. The proportional-integral observer may estimate rotor information of the motor by performing an operation on the calculated error based on a characteristic of the motor.

### CROSS-REFERENCE TO RELATED APPLICATION

This application claims priority from and the benefit of Korean Patent Application No. 10-2014-0157156 filed on Nov. 12, 2014, which is hereby incorporated by reference for all purposes as if fully set forth herein.

### BACKGROUND

1. Field

Exemplary embodiments relate to a rotor information estimation system.

2. Discussion of the Background

An alternating current (AC) motor control system is a system that is applied to a hybrid electric vehicle, an electric vehicle, and the like, and drives a vehicle and various devices of the vehicle by controlling an AC motor. The AC motor control system controls the AC monitor using rotor location information of the AC motor. The AC motor control system generally uses a resolver to obtain rotor location information.

The resolver, a rotor location (angle) detector using an analog detection method, is mounted to a rotation shaft of the AC motor, measures a location of a rotor based on an excitation signal applied, and in this instance, outputs AC voltage corresponding to the measured rotor location.

The AC voltage output from the resolver is classified into a sine signal and a cosine signal and thereby output. The AC motor control system also uses a resolver-to-digital chip (RDC) that converts rotor location information output from the resolver to a digital value.

The RDC converts a sine signal and a cosine signal of the resolver to digital values. However, recently, to achieve cost reduction, there is a need for a method of detecting a rotor location by directly converting the sine signal and the cosine signal of the resolver to digital values in a micro computer of the AC motor control system without using an RDC integrated chip (IC).

As a conventional method of directly converting a sine signal and a cosine signal of the resolver to digital values, there is a method using an angle tracking observer.

Describing the method using the angle tracking observer with reference to FIG. 1, this method may be expressed through the following Equation 1.

$$F ( s ) = \frac{\hat{θ} ( s )}{θ ( s )} = \frac{{K}_{1} ( 1 + {K}_{2} s )}{{s}^{2} + {K}_{1} {K}_{2} s + {K}_{1}} \qquad [ Equation 1 ]$$

In Equation 1, F(s) denotes a system using the angle tracking observer, \hat{θ} denotes a rotor location measured by the angle tracking observer, θ denotes a rotor location estimated by the resolver, K₁ and K₂ denote gain, and s denotes a Laplace operator. Here, K₁ and K₂ are determined according to the following Equation 2.

$${K}_{1} = {ω}_{n}^{2} , {K}_{2} = \frac{2 ζ}{{ω}_{n}} \qquad [ Equation 2 ]$$

In Equation 2, ωₙ denotes a natural frequency based on the angle tracking observer and ζ denotes a damping factor based on the angle tracking observer.

The method using the angle tracking observer as above is applied to a closed loop system, and calculates an error of the rotor location measured by the resolver using the rotor location estimated by the angle tracking observer.

The method using the angle tracking observer estimates the rotor location using the calculated error and thus, has an advantage in that the estimated rotor location is highly accurate. However, the method using the angle tracking observer is vulnerable to disturbances and does not consider physical characteristics of the AC motor and thus can have an issue in the estimated rotor location being incorrect when a physical characteristic of the AC motor has been changed.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a rotor information estimation system that is modeled based on a mechanical characteristic of an alternating current (AC) motor to be capable of accurately calculating an error of a rotor location measured by a resolver and also capable of accurately estimating a motor rotor location using the calculated error.

Additional aspects will be set forth in the detailed description which follows, and, in part, will be apparent from the disclosure, or may be learned by practice of the inventive concept.

Exemplary embodiments provide a rotor information estimation system, comprising: a resolver configured to measure a rotor location of a motor; a proportional-integral observer based on the motor and configured to estimate the rotor location of the motor; and an error calculator configured to calculate an error of the rotor location measured by the resolver using the rotor location estimated by the proportional-integral observer. The proportional-integral observer may estimate rotor information of the motor by performing an operation on the calculated error based on a characteristic of the motor.

According to exemplary embodiments, the proportional-integral observer may comprise: a gain unit configured to multiply and thereby output the error and a gain; an operation unit configured to perform an operation on and thereby output the output of the gain unit and a variable according to the characteristic of the motor; an addition unit configured to add and thereby output the output of the gain unit and the output of the operation unit; a first integrator configured to estimate the rotor location in the rotor information by integrating the output of the addition unit; and a second integrator configured to estimate a load torque in the rotor information by integrating the output of the gain unit.

The gain unit may comprise: a first gain unit configured to multiply and thereby output the error and a first gain; a second gain unit configured to multiply and thereby output the error and a second gain; and a third gain unit configured to multiply and thereby output the error and a third gain.

The first gain, the second gain, and the third gain may be determined based on a characteristic equation of the proportional-integral observer.

The characteristic equation of the proportional-integral observer may be expressed according to an equation,

$$det [ sI - ( A - LC ) ] = {s}^{3} + \frac{{L}_{1} \hat{J} + \hat{B}}{\hat{J}} {s}^{2} + \frac{{L}_{2} \hat{J} + {L}_{1} \hat{B}}{\hat{J}} s - \frac{{L}_{3}}{\hat{J}} = 0$$

Here, s denotes a Laplace operator, L₁ denotes the first gain, L₂ denotes the second gain, L₃ denotes the third gain, \hat{B} denotes a coefficient of friction of the motor, and Ĵ denotes a moment of inertia of the motor.

The characteristic equation of the proportional-integral observer may be expressed according to an equation based on a pole of a tertiary system,

α=(s−β1)(s−β2)(s−β3)=s³−(β1+β2+β3)s²+(β1β2+β2β3+β3β1)−β1β2β3=0

The first gain, the second gain, and the third gain may be calculated based on the characteristic equation,

$${L}_{1} = - 3 β - \frac{\hat{B}}{\hat{J}}$$

$${L}_{2} = 3 {β}^{2} - \frac{\hat{B}}{\hat{J}} {L}_{1} = 3 {β}^{2} + 3 β \frac{\hat{B}}{\hat{J}} + {( \frac{\hat{B}}{\hat{J}} )}^{2}$$

$${L}_{3} = {β}^{3} \hat{J}$$

According to exemplary embodiments, the operation unit may comprise: a first multiplier configured to multiply and thereby output the output of the second gain unit and a moment of inertia of the motor; an operator configured to add the output of the first multiplier and an output torque of the motor, to subtract the output of the second multiplier from a result of the addition, and thereby output a result of the subtraction; a second multiplier configured to multiply and thereby output the output of the operator and an inverse number of a moment of inertia of the motor; a third integrator configured to estimate a rotor velocity in the rotor information by integrating the output of the second multiplier; and a third multiplier configured to multiply the output of the third integrator and a coefficient of friction of the motor, and thereby output a result of the multiplication to the operator.

The operator may subtract the output of the third multiplier and thereby output a result of the subtraction to the second multiplier.

The addition unit may add the output of the first gain unit and thereby output a result of the addition to the first integrator.

The second integrator may integrate the output of the third gain unit and thereby output a result of the integration to the operator.

According to exemplary embodiments, the error calculator may comprise: a first multiplier operator configured to multiply and thereby output a cosine signal of the output of the first integrator and a sine signal of the rotor location measured by the resolver; a second multiplier operator configured to multiply and thereby output a sine signal of the output of the first integrator and a cosine signal of the rotor location measured by the resolver; and a subtractor configured to subtract the output of the second multiplier operator from the output of the first multiplier operator and thereby output a result of the subtraction to the gain unit.

The motor may be a permanent magnet synchronous motor.

A machine model of the motor may be expressed according to an equation,

$${T}_{e} = J \frac{d {ω}_{rm}}{d t} + B {ω}_{rm} + {T}_{L}$$

Here, Tₑ denotes an output torque of the motor, J denotes a moment of inertia of the motor, ωᵣₘ denotes an angular velocity, B denotes a coefficient of friction, and T_{L} denotes a load torque.

The proportional-integral observer may be modeled according to an equation,

$$\dot{x} = Ax + Bu$$

$$y = Cx$$

$$\frac{d}{d t} [ \begin{matrix}{θ}_{rm} \\ {ω}_{rm} \\ {\hat{T}}_{L}\end{matrix} ] = [ \begin{matrix}0 & 1 & 0 \\ 0 & - \frac{{B}_{mot}}{{J}_{mot}} & - \frac{1}{{J}_{mot}} \\ 0 & 0 & 0\end{matrix} ] [ \begin{matrix}{θ}_{rm} \\ {ω}_{rm} \\ {\hat{T}}_{L}\end{matrix} ] + [ \begin{matrix}0 \\ \frac{1}{{J}_{mot}} \\ 0\end{matrix} ] {T}_{e}^{*}$$

$$y = [ \begin{matrix}1 & 0 & 0 ]\end{matrix} [ \begin{matrix}{θ}_{rm} \\ {ω}_{rm} \\ {\hat{T}}_{L}\end{matrix} ] = {θ}_{rm}$$

Here, θᵣₘ denotes a rotor location, ωᵣₘ denotes a rotor velocity that is the angular velocity, \hat{T}_{L} denotes a load torque of the motor, Bₘₒₜ denotes a coefficient of friction of the motor, and Jₘₒₜ denotes a moment of inertia of the motor.

The proportional-integral observer may be modeled according to an equation,

$$\dot{\hat{x}} = \hat{A} \hat{x} + \hat{B} u + L ( y - C \hat{x} ) \\ \frac{d}{d t} [ \begin{matrix}{\hat{θ}}_{rm} \\ {\hat{ω}}_{rm} \\ {\hat{T}}_{L}\end{matrix} ] = [ \begin{matrix}0 & 1 & 0 \\ 0 & - \frac{\hat{B}}{\hat{J}} & - \frac{1}{\hat{J}} \\ 0 & 0 & 0\end{matrix} ] [ \begin{matrix}{\hat{θ}}_{rm} \\ {\hat{ω}}_{rm} \\ {\hat{T}}_{L}\end{matrix} ] + [ \begin{matrix}0 \\ \frac{1}{\hat{J}} \\ 0\end{matrix} ] {T}_{e}^{*} + [ \begin{matrix}{L}_{1} \\ {L}_{2} \\ {L}_{3}\end{matrix} ] ( {θ}_{rm} - \begin{matrix}[ 1 & 0 & 0 ]\end{matrix} [ \begin{matrix}{\hat{θ}}_{rm} \\ {\hat{ω}}_{rm} \\ {\hat{T}}_{L}\end{matrix} ] )$$

Here, θᵣₘ denotes an estimated rotor location, ωᵣₘ denotes an estimated rotor velocity, \hat{T}_{L} denotes an estimated load torque, θᵣₘ denotes a resolver output that is the rotor location, \hat{B} denotes the coefficient of friction of the motor, Ĵ denotes the moment of inertia of the motor, T*ₑ denotes an output torque of the motor, L₁ denotes a first gain, L₂ denotes a second gain, and L₃ denotes a third gain.

A rotor information estimation system according to exemplary embodiments may accurately calculate an error of a motor rotor location measured by a resolver using a proportional-integral observer modeled based on a characteristic of a motor.

Since it is possible to accurately estimate a rotor location by performing an operation on the calculated error and a gain according to the motor characteristic, and to control the motor using the accurately estimated rotor location, it is possible to remarkably improve a motor control performance.

When the characteristic of the motor is changed, it is possible to change a gain of the proportional-integral observer to correspond to the changed motor characteristic and thus, it is possible to accurately calculate motor rotor information even though the characteristic of the motor is changed.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a functional block diagram illustrating a detailed configuration of an angle tracking observer according to a related art.

FIG. 2 is a block diagram briefly illustrating a rotor information estimation system according to an exemplary embodiment.

FIG. 3 is a functional block diagram illustrating a detailed configuration of a rotor information estimation system according to an exemplary embodiment.

FIG. 4 is a flowchart briefly illustrating a rotor information estimation method for controlling a motor according to an exemplary embodiment.

FIG. 5 is a graph about an output signal of a resolver according to an exemplary embodiment.

FIGS. 6A, 6B, 7A, 7B, 8A and 8B are graphs to describe an estimation performance of a proportional-integral observer according to an exemplary embodiment.

FIGS. 9, 10, and 11 are graphs to describe an estimation error of a proportional-integral observer according to an exemplary embodiment.

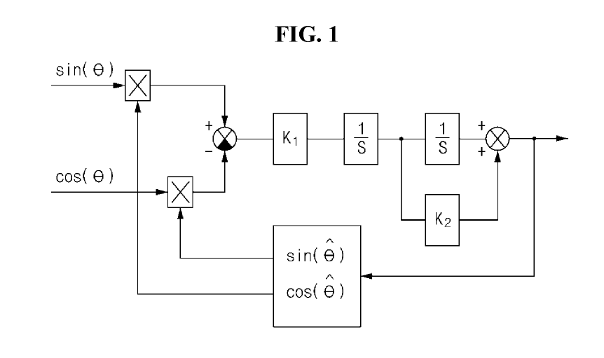

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the exemplary embodiments throughout the several figures of the drawing.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

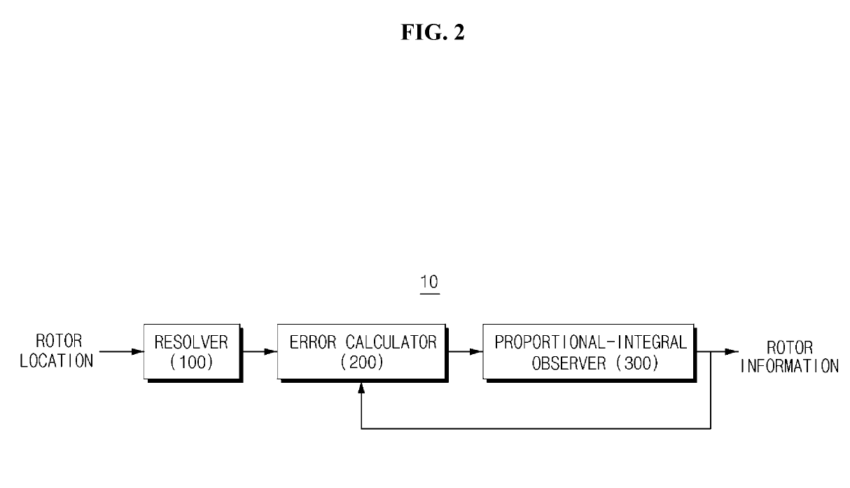

Referring to FIG. 2, a rotor information estimation system 10 according to an exemplary embodiment may include a resolver 100, an error calculator 200, and a proportional-integral observer 300.

The resolver 100, as a location (angle) measurement sensor, is mounted to a rotation shaft of a motor. When a rotor of the motor rotates, a rotor of the resolver 100 simultaneously rotates. In this instance, the resolver 100 may output rotor location information of the resolver 100 as a sine signal and a cosine signal.

The motor may be a driving motor that serves as an engine of a hybrid electric vehicle or an electric vehicle. For example, the motor may be a permanent magnet synchronous motor (PMSM) that is an alternating current (AC) motor.

The error calculator 200 is a device that calculates an error of a motor rotor location measured by the resolver 100. The error calculator 200 may receive motor rotor location from the resolver 100, and may receive estimated motor rotor location information from the proportional-integral observer 300, and calculates an error of the motor rotor location calculated by the resolver 100 based on the aforementioned two pieces of information.

The proportional-integral observer 300 is a device that is modeled based on a variable indicating a mechanical characteristic of the motor to estimate a rotor location of the motor. The proportional-integral observer 300 may estimate the rotor location of the motor by performing an operation on the error calculated by the error calculator 200 and a gain according to a motor characteristic, and may also estimate a rotor velocity of the motor and a load torque of the motor. Here, the estimated rotor location, rotor velocity, and load torque of the motor are used as an input for an inverter to control the motor.

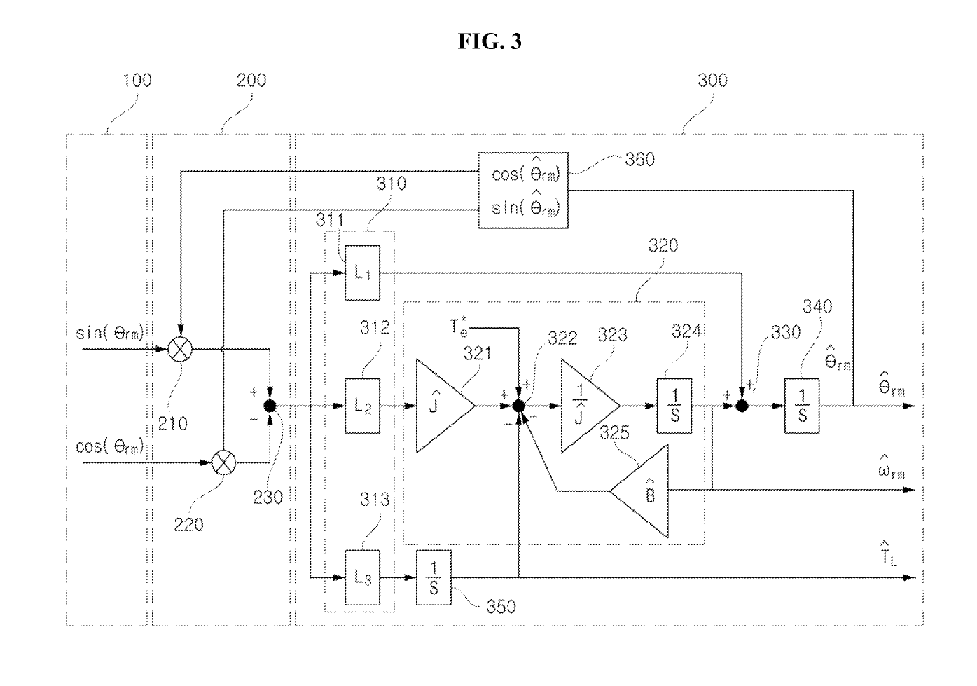

Referring to FIG. 3, the resolver 100 measures a rotor location of the motor and outputs the measured rotor location of the motor as a sine signal (sin(θᵣₘ)) and cosine signal (cos(θᵣₘ)).

The error calculator 200, as a device to calculate an error of the rotor location measured by the resolver 100, may include a first multiplier operator 210, a second multiplier operator 220, and a subtractor 230.

The first multiplier operator 210 may receive, from the resolver 100, the sine signal (sin(θᵣₘ)) denoting the rotor location. The first multiplier operator 210 may be connected to an output end of the proportional-integral observer 300 and may receive a cosine signal (cos(\hat{θ}ᵣₘ)) about the rotor location estimated by the proportional-integral observer 300. The first multiplier operator 210 may multiply and thereby output the sine signal (sin θᵣₘ) received from the resolver 100 and the cosine signal (cos(\hat{θ}rm)) received from the proportional-integral observer 300.

The second multiplier operator 220 may be connected to an output end of the resolver 100 and may receive, from the resolver 100, the cosine signal (cos θᵣₘ) denoting the rotor location. The second multiplier operator 220 may be connected to the output end of the proportional-integral observer 300 and may receive a sine signal (sin(\hat{θ}ᵣₘ)) of the rotor location estimated by the proportional-integral observer 300. The second multiplier operator 220 may multiply and thereby output the cosine signal (cos θᵣₘ) received from the resolver 100 and the sine signal (sin(\hat{θ}ᵣₘ)) received from the proportional-integral observer 300.

The subtractor 230 may be connected to output ends of the first multiplier operator 210 and the second multiplier operator 220 and may receive output signals of the first multiplier operator 210 and the second multiplier operator 220. The subtractor 230 may subtract the output signal of the second multiplier operator 220 from the output signal of the first multiplier operator 210 and thereby output a result of the subtraction. Here, the output of the subtractor 230 corresponds to an error (sin(θᵣₘ−\hat{θ}ᵣₘ)) of the rotor location measured by the resolver 100.

An error calculation of the error calculator 200 may be induced from the following Equation 3.

sin(θ−\hat{θ}))=sin(θ)cos(\hat{θ})−cos(θ)sin(\hat{θ})≅θ−\hat{θ} [Equation 3]

In Equation 3, sin(θ−\hat{θ}) denotes an error output from the subtractor 230, sin(θ) cos(\hat{θ}) denotes the output of the first multiplier operator 210, and cos(θ) sin(\hat{θ}) denotes the output of the second multiplier operator 220. θ−\hat{θ} denotes a difference between the rotor location measured by the resolver 100 and the rotor location estimated by the proportional-integral observer 300. It denotes a value approximate to the error (sin(θ−\hat{θ})) output from the subtractor 230.

The proportional-integral observer 300, as a device to estimate rotor information such as a rotor location, a rotor velocity, and a load torque of the motor, may be modeled based on a machine model of a motor (PMSM) expressed by the following Equation 4.

$${T}_{e} = J \frac{d {ω}_{rm}}{d t} + B {ω}_{rm} + {T}_{L} \qquad [ Equation 4 ]$$

In Equation 4, Tₑ denotes an output torque of the motor, J denotes a moment of inertia of the motor, ωᵣₘ denotes an angular velocity, B denotes a coefficient of friction, and T_{L} denotes a load torque. In this instance, since a change in the load torque affects a rotation velocity of the motor, the change in the load torque may be regarded as low frequency turbulence. Accordingly, the proportional-integral observer 300 may be finally modeled as expressed by Equation 6 based on Equation 5.

$$\begin{matrix} \dot{x} = Ax + Bu & [ Equation 5 ] \\ y = Cx & \\ \frac{d}{d t} [ \begin{matrix}{θ}_{rm} \\ {ω}_{rm} \\ {\hat{T}}_{L}\end{matrix} ] = [ \begin{matrix}0 & 1 & 0 \\ 0 & - \frac{{B}_{mot}}{{J}_{mot}} & - \frac{1}{{J}_{mot}} \\ 0 & 0 & 0\end{matrix} ] [ \begin{matrix}{θ}_{rm} \\ {ω}_{rm} \\ {\hat{T}}_{L}\end{matrix} ] + [ \begin{matrix}0 \\ \frac{1}{{J}_{mot}} \\ 0\end{matrix} ] {T}_{e}^{*} & \\ y = [ \begin{matrix}1 & 0 & 0 ]\end{matrix} [ \begin{matrix}{θ}_{rm} \\ {ω}_{rm} \\ {\hat{T}}_{L}\end{matrix} ] = {θ}_{rm} & \end{matrix}$$

In Equation 5, θᵣₘ denotes the rotor location, ωᵣₘ denotes the rotor velocity that is the angular velocity, \hat{T}_{L} denotes the load torque of the motor, Bₘₒₜ denotes the coefficient of friction of the motor, and Jₘₒₜ denotes the moment of inertia of the motor.

$$\begin{matrix} \dot{\hat{x}} = \hat{A} \hat{x} + \hat{B} u + L ( y - C \hat{x} ) & [ Equation 6 ] \\ \frac{d}{d t} [ \begin{matrix}{\hat{θ}}_{rm} \\ {\hat{ω}}_{rm} \\ {\hat{T}}_{L}\end{matrix} ] = [ \begin{matrix}0 & 1 & 0 \\ 0 & - \frac{\hat{B}}{\hat{J}} & - \frac{1}{\hat{J}} \\ 0 & 0 & 0\end{matrix} ] [ \begin{matrix}{\hat{θ}}_{rm} \\ {\hat{ω}}_{rm} \\ {\hat{T}}_{L}\end{matrix} ] + [ \begin{matrix}0 \\ \frac{1}{\hat{J}} \\ 0\end{matrix} ] {T}_{e}^{*} + [ \begin{matrix}{L}_{1} \\ {L}_{2} \\ {L}_{3}\end{matrix} ] ( {θ}_{rm} - \begin{matrix}[ 1 & 0 & 0 ]\end{matrix} [ \begin{matrix}{\hat{θ}}_{rm} \\ {\hat{ω}}_{rm} \\ {\hat{T}}_{L}\end{matrix} ] ) & \end{matrix}$$

In Equation 6, \hat{θ}ᵣₘ denotes an estimated rotor location, \hat{ω}ᵣₘ denotes an estimated rotor velocity, \hat{T}_{L} denotes an estimated load torque, θᵣₘ denotes a resolver output (rotor location), \hat{B} denotes the coefficient of friction of the motor, Ĵ denotes the moment of inertia of the motor, T*ₑ denotes an output torque of the motor, L₁ denotes a first gain, L₂ denotes a second gain, and L₃ denotes a third gain.

The proportional-integral observer 300 modeled as expressed by Equation 6 may include a gain unit 310, an operation unit 320, an addition unit 330, a first integrator 340, a second integrator 350, and a distributor 360.

The gain unit 310 may be connected to an output end of the subtractor 230 and may receive, from the subtractor 230, the error of the rotor location calculated by the resolver 100. The gain unit 310 may multiply and thereby output the received error and a gain. The gain includes a first gain, a second gain, and a third gain. The first gain, the second gain, and the third gain may be determined based on a characteristic equation (Equation 7) of the proportional-integral observer 300 modeled based on the motor characteristic.

$$det [ sI - ( A - LC ) ] = {s}^{3} + \frac{{L}_{1} \hat{J} + \hat{B}}{\hat{J}} {s}^{2} + \frac{{L}_{2} \hat{J} + {L}_{1} \hat{B}}{\hat{J}} s - \frac{{L}_{3}}{\hat{J}} = 0 \qquad [ Equation 7 ]$$

Equation 7 may be converted to and thereby expressed by a characteristic equation (Equation 8) by a pole (β1, β2, and β3) of a tertiary system. Here, the pole serves to determine a stability and a time response characteristic of a system.

α=(s−β1)(s−β2)(s−β3)=s³−(β1+β2β3)s²+(β1β2+β2β3+β3β1)−β1β2β3=0 [Equation 8]

When the pole of the tertiary system is selected as a triple root such as β=β1=β2=β3, a gain of the proportional-integral observer 300 may be obtained through Equation 7 and Equation 8, as expressed by the following Equation 9.

$$\begin{matrix}{L}_{1} = - 3 β - \frac{\hat{B}}{\hat{J}} \\ & [ Equation 9 ] \\ {L}_{2} = 3 {β}^{2} - \frac{\hat{B}}{\hat{J}} {L}_{1} = 3 {β}^{2} + 3 β \frac{\hat{B}}{\hat{J}} + {( \frac{\hat{B}}{\hat{J}} )}^{2} & \\ {L}_{3} = {β}^{3} \hat{J} & \end{matrix}$$

In Equation 9, β is selected by considering an application system, and the first gain (L₁), the second gain (L₂), and the third gain (L₃) of the proportional-integral observer 300 are determined based on the selected β.

The gain unit 310 may include a first gain unit 311, a second gain unit 312, and a third gain unit 313. Here, the first gain unit 311 may multiply and thereby output an error corresponding to the output of the subtractor 230 and the first gain, the second gain unit 312 may multiply and thereby output the error corresponding to the output of the subtractor 230 and the second gain, and the third gain unit 313 may multiply and thereby output the error corresponding to the output of the subtractor 230 and the third gain.

The operation unit 320 may include a first multiplier 321, an operator 322, a second multiplier 323, a third integrator 324, and a third multiplier 325.

The first multiplier 321 may be connected to an output end of the second gain unit 312, may receive an output (L₂(θᵣₘ-\hat{θ}ᵣₘ)) of the second gain unit 312, and may multiply and thereby output the received output (L₂(θᵣₘ−\hat{θ}ᵣₘ)) of the second gain unit 312 and the moment of inertia (Ĵ) of the motor.

The operator 322, as a type of subtractor/adder, may be connected to an output end of the first multiplier 321, may receive the output of the first multiplier 321, and may add and thereby output the output (L₂(θᵣₘ−\hat{θ}ᵣₘ)*Ĵ) of the first multiplier 321 and the output torque (Tₑ) of the motor.

The second multiplier 323 may be connected to an output end of the operator 322, may receive the output of the operator 322, and may multiply and thereby output the output of the operator 322 and an inverse number (1/Ĵ) of the moment of inertia (Ĵ).

The third integrator 324 may be connected to an output end of the second multiplier 323, may receive the output of the second multiplier 323, and may estimate a rotor velocity (ωᵣₘ) of the motor by integrating the output of the second multiplier 323.

The third multiplier 325 may be connected to an output end of the third integrator 324, may receive the output of the third integrator 324, and may multiply the output of the third integrator 324 and the coefficient of friction (\hat{B}) and thereby output a result of the multiplication to the operator 322. Here, the operator 322 may be connected to an output end of the third multiplier 325 and an input end of the second multiplier 323, may subtract the output of the third multiplier 325 from the preceding calculated output and thereby output a result of the subtraction to the second multiplier 323.

The addition unit 330 may be connected to the output end of the third integrator 324 and the output end of the first gain unit 311, may receive the output of the third integrator 324 and the output of the first gain unit 311, and may add and thereby output the output of the third integrator 324 and the output of the first gain unit 311.

The first integrator 340 may be connected to an output end of the addition unit 330, may receive the output of the addition unit 330, and may estimate a rotor location (\hat{θ}ᵣₘ) of the motor by integrating the output of the addition unit 330.

The second integrator 350 may be connected to an output end of the third gain unit 313, may receive the output of the third gain unit 313, and may estimate the load torque (T_{L}) of the motor by integrating the output (L₃(θᵣₘ-\hat{θ}ᵣₘ)) of the third gain unit 313. Here, the operator 322 may be connected to an output end of the second integrator 350, may receive the output of the second integrator 350, and may further add and thereby output the preceding calculated output and the output (T_{L}) of the second integrator 350.

The distributor 360 may be connected to an output end of the first integrator 340, may receive the output of the first integrator 340, and may distribute and thereby output the output (\hat{θ}ᵣₘ) of the first integrator 340 as a sine signal (sin(\hat{θ}ᵣₘ)) and a cosine signal (cos(\hat{θ}ᵣₘ)). Here, the first multiplier operator 210 of the error calculator 200 may be connected to a first output end of the distributor 360 and may receive the cosine signal (cos(\hat{θ}ᵣₘ)) from the distributor 360, and the second multiplier operator 220 of the error calculator 200 may be connected to a second output end of the distributor 360 and may receive the sine signal (sin(\hat{θ}ᵣₘ)) from the distributor 360. Through this, the subtractor 230 of the error calculator 200 may calculate an error of the output of the resolver 100 by subtracting the output of the second multiplier operator 222 from the output of the first multiplier operator 210.

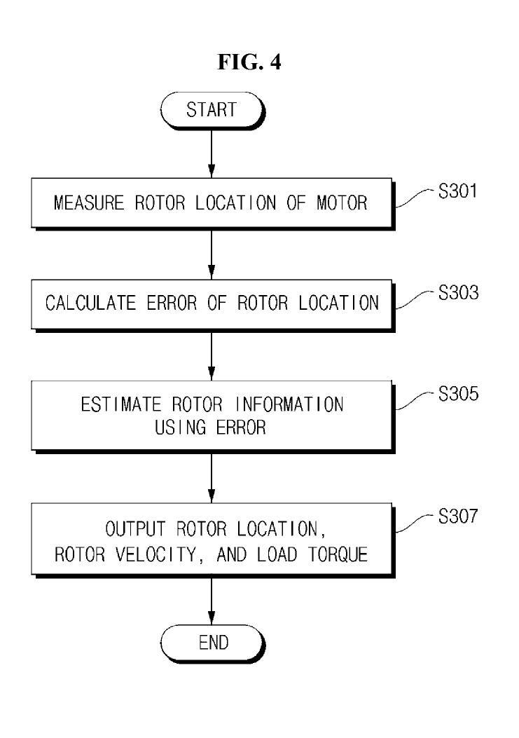

Referring to FIGS. 2 through 4, a rotor information estimation method for controlling a motor according to an exemplary embodiment of the present invention may include operation S301 of measuring a rotor location of a motor, operation S303 of calculating an error of the rotor location, operation S305 of estimating rotor information using the error, and operation S307 of outputting a rotor location, a rotor velocity, and a load torque.

In measuring operation S301, the resolver 100 measures the rotor location of the motor. Here, the resolver 100 may output the rotor location of the motor as AC voltage (sine and cosine).

In calculating operation S303, the error calculator 200 calculates the error of the motor rotor location measured by the resolver 100. Here, the error may be calculated based on the rotor location estimated by the proportional-integral observer 300.

In estimating operation S305, the proportional-integral observer 300 estimates rotor information using the calculated error. Here, the proportional-integral observer 300 may estimate rotor information by integrating output information that is finally calculated by multiplying the calculated error and a gain according to a motor characteristic and by applying the aforementioned various types of operation processes.

In outputting operation S307, the proportional-integral observer 300 outputs rotor information estimated for controlling the motor. Here, the rotor information may include the rotor location of the motor, the rotor velocity of the motor, and the load torque of the motor. The rotor location in the rotor information may be fed back, and is used for the error calculation by the error calculator 200 in calculating operation S303.

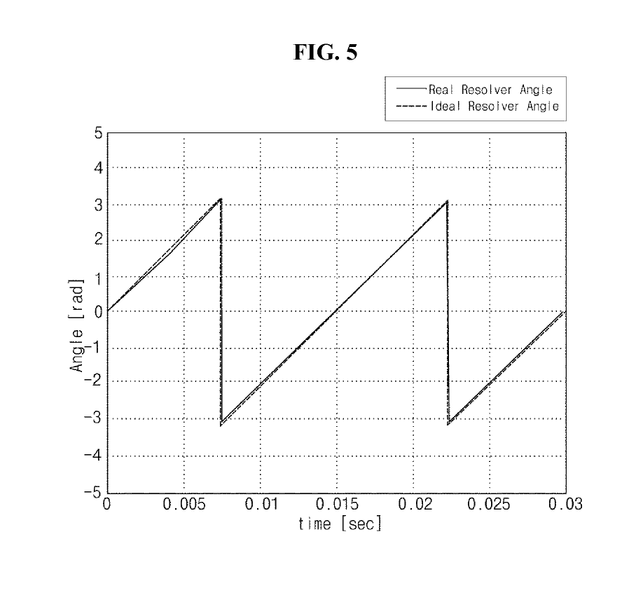

Referring to FIG. 5, it is possible to verify an ideal output (ideal resolver angle) of the resolver 100 and a real output (real resolver angle) of the resolver 100 with respect to a time. Due to a physical characteristic, the same sine wave (distortion signal) as a rotation cycle of the motor is included in the real resolver angle. Accordingly, an observer to convert the resolver angle to a digital value needs to be capable of accurately measuring a distortion signal. A proportional-integral observer according to an exemplary embodiment may accurately measure a distortion signal and may estimate rotor information of the motor through the accurately estimated distortion signal.

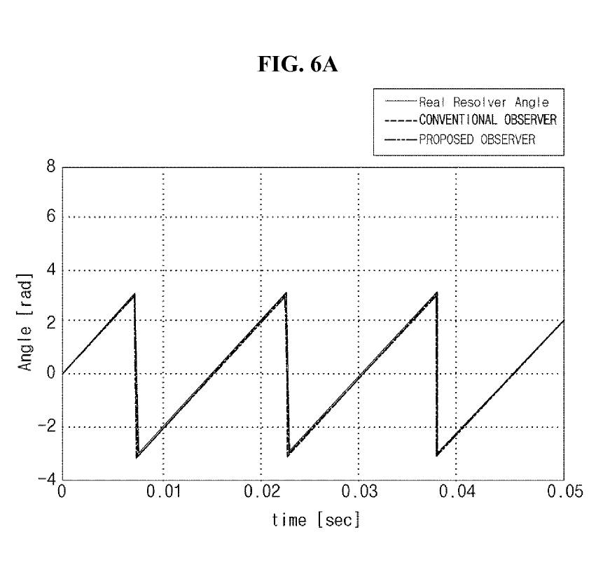

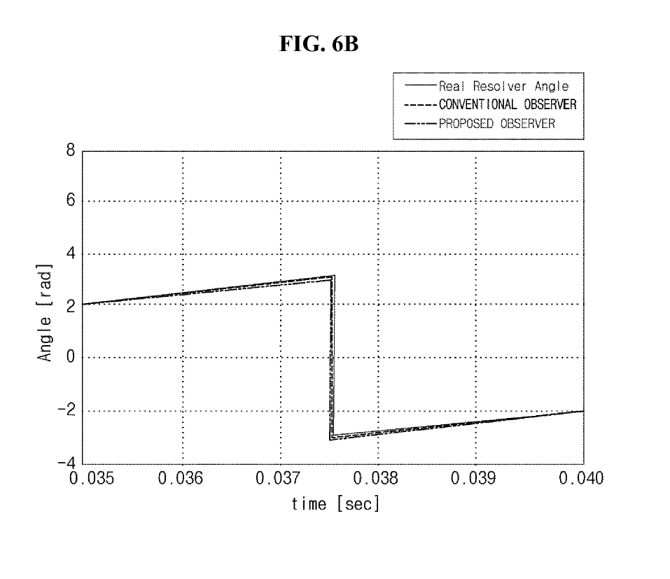

Referring to FIGS. 6A and 6B, FIG. 6A shows a real resolver angle, a conventional observer angle, and a proposed proportional-integral observer angle according to a rotor velocity (500 rpm) of the motor. FIG. 6B is a graph in which a predetermined portion of FIG. 6A is enlarged. Here, the conventional observer indicates an angle tracking observer.

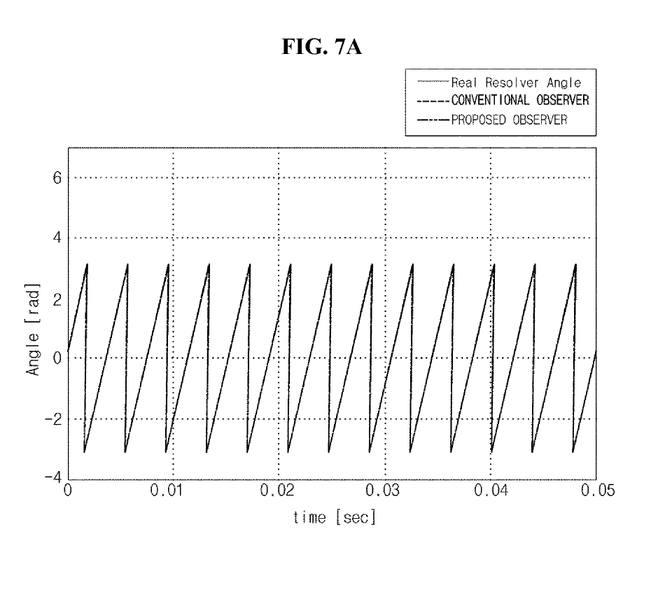

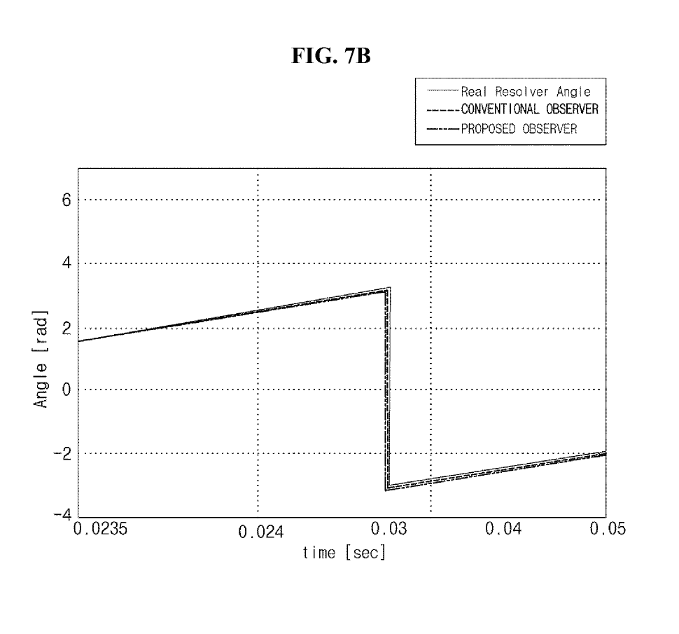

Referring to FIGS. 7A and 7B, FIG. 7A shows a real resolver angle, a conventional observer angle, and a proposed proportional-integral observer angle according to a rotor velocity (2000 rpm) of the motor. FIG. 7B is a graph in which a predetermined portion of FIG. 7A is enlarged. Here, the conventional observer indicates an angle tracking observer.

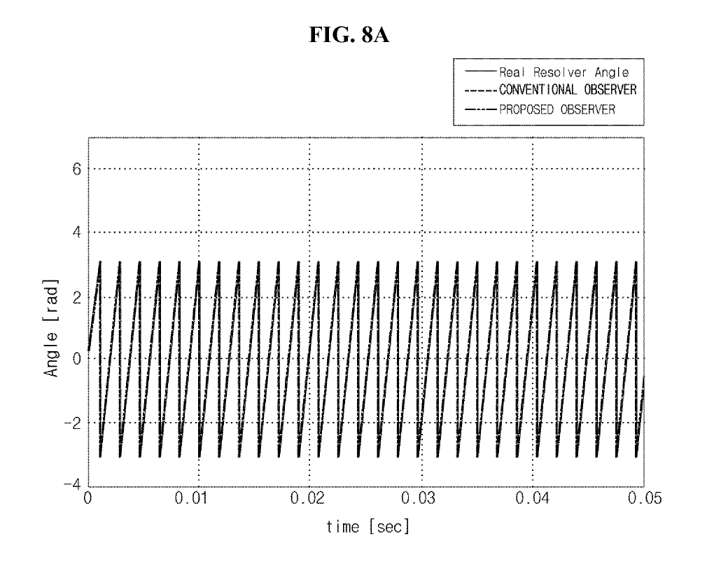

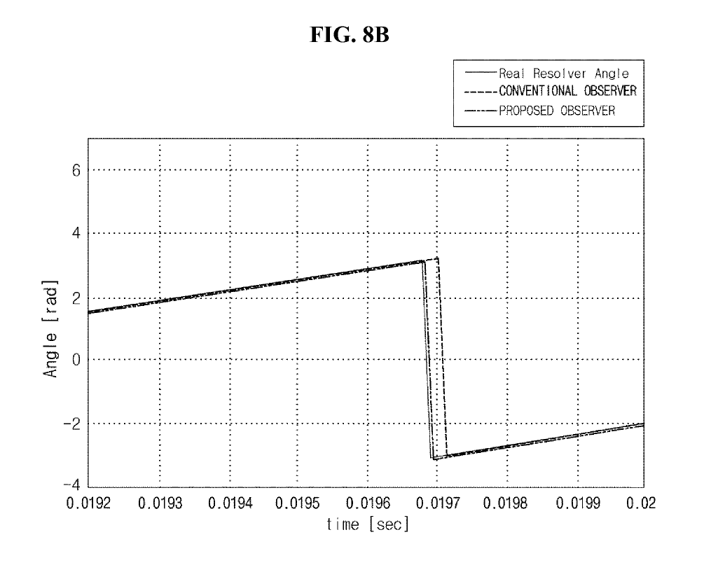

Referring to FIGS. 8A and 8B, FIG. 8A shows a real resolver angle, a conventional observer angle, and a proposed proportional-integral observer angle according to a rotor velocity (4000 rpm) of the motor. FIG. 8B is a graph in which a predetermined portion of FIG. 8A is enlarged. Here, the conventional observer indicates an angle tracking observer.

Referring to the graph of FIGS. 6A and 6B, a difference among the real resolver angle, the conventional observer angle, and the proposed proportional-integral observer angle barely exists. However, referring to the graphs of FIGS. 7A, 7B, 8A and 8B, a difference among the real resolver angle, the conventional observer angle, and the proposed proportional-integral observer angle is on increase. It indicates that a delay has occurred in the conventional observer angle as the velocity of the motor increases, and shows that the proposed proportional-integral observer angle has estimated the rotor location more quickly than the conventional observer.

Referring to FIG. 9, it is possible to verify an error between the rotor location estimated by the conventional observer and the rotor location estimated by the proposed proportional-integral observer angle according to the rotor velocity (500 rpm) of the motor.

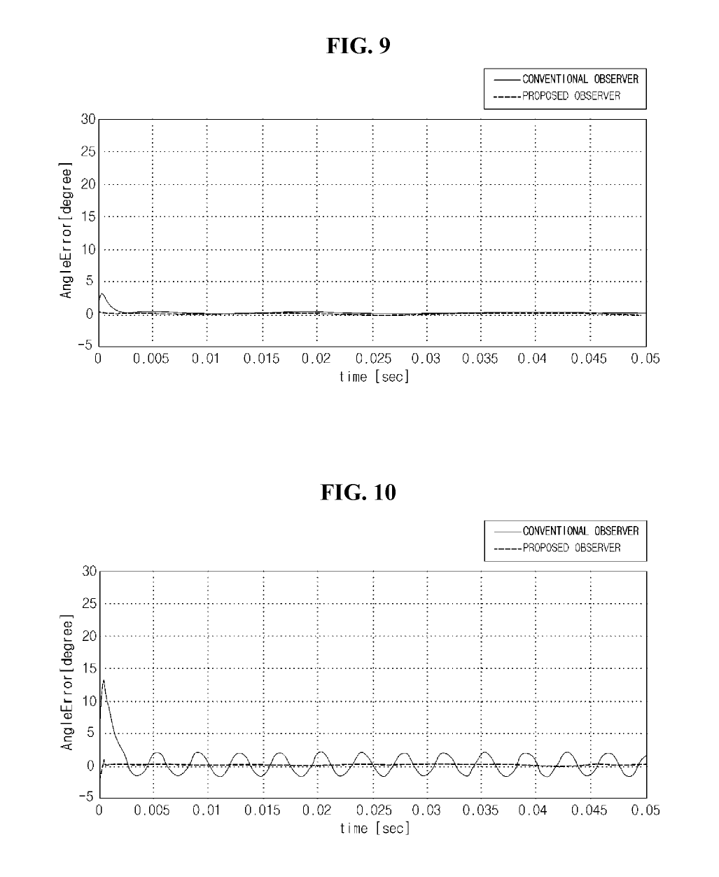

Referring to FIG. 10, it is possible to verify an error between the rotor location estimated by the conventional observer and the rotor location estimated by the proposed proportional-integral observer angle according to the rotor velocity (2000 rpm) of the motor.

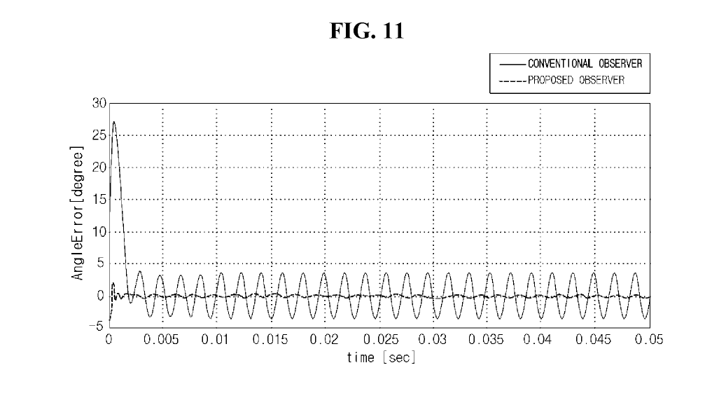

Referring to FIG. 11, it is possible to verify an error between the rotor location estimated by the conventional observer and the rotor location estimated by the proposed proportional-integral observer angle according to the rotor velocity (4000 rpm) of the motor.

As described above with reference to FIGS. 9 through 11, the error of the proposed proportional-integral observer angle is smaller than the error of the conventional observer over the entire velocity area. For example, when a rotation velocity of the motor is 4000 rpm, a normal state error of the conventional observer was ±3.683 degrees and a transient error (overshoot maximum value) was 27.75 degrees. In contrast, a normal state error of the proposed proportional-integral observer was ±0.210 degrees and a transient error was 7.22 degrees.

Accordingly, a rotor information estimation system according to an exemplary embodiment of the present invention may accurately estimate a motor rotor location using a newly modeled proportional-integral observer.

In exemplary embodiments, a rotor information estimation system, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, a rotor information estimation system, and/or one or more components thereof may include or otherwise be associated with one or more memories (not shown) including code (e.g., instructions) configured to cause a rotor information estimation system, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A rotor information estimation system, comprising:
a resolver configured to measure a rotor location of a motor;
a proportional-integral observer based on the motor and configured to estimate the rotor location of the motor; and
an error calculator configured to calculate an error of the rotor location measured by the resolver using the rotor location estimated by the proportional-integral observer,
wherein the proportional-integral observer is further configured to estimate rotor information of the motor by performing an operation on the calculated error based on a characteristic of the motor.

2. The system of claim 1, wherein the proportional-integral observer comprises:
a gain unit configured to multiply the error and a gain, and provide an output;
an operation unit configured to perform an operation on the output of the gain unit and a variable according to the characteristic of the motor, and provide an output;
an addition unit configured to add the output of the gain unit and the output of the operation unit, and provide an output;
a first integrator configured to estimate the rotor location in the rotor information by integrating the output of the addition unit; and
a second integrator configured to estimate a load torque in the rotor information by integrating the output of the gain unit.

3. The system of claim 2, wherein the gain unit comprises:
a first gain unit configured to multiply the error and a first gain, and provide an output;
a second gain unit configured to multiply the error and a second gain, and provide an output; and
a third gain unit configured to multiply the error and a third gain, and provide an output.

4. The system of claim 3, wherein the first gain, the second gain, and the third gain are configured to be determined based on a characteristic equation of the proportional-integral observer.

5. The system of claim 4, wherein the characteristic equation of the proportional-integral observer is expressed according to an equation,
$$det [ sI - ( A - LC ) ] = {s}^{3} + \frac{{L}_{1} \hat{J} + \hat{B}}{\hat{J}} {s}^{2} + \frac{{L}_{2} \hat{J} + {L}_{1} \hat{B}}{\hat{J}} s - \frac{{L}_{3}}{\hat{J}} = 0$$
where s denotes a Laplace operator, L₁ denotes the first gain, L₂ denotes the second gain, L₃ denotes the third gain, \hat{B} denotes a coefficient of friction of the motor, and Ĵ denotes a moment of inertia of the motor.

6. The system of claim 5, wherein the characteristic equation of the proportional-integral observer is expressed according to an equation based on a pole of a tertiary system,
α=(s−β1)(s−β2)(s−β3)=s³−(β1+β2+β3)s²+(β1β2+β2β3+β3β1)−β1β2β3=0

7. The system of claim 6, wherein the first gain, the second gain, and the third gain are calculated based on the characteristic equation,
$${L}_{1} = - 3 β - \frac{\hat{B}}{\hat{J}}$$
$${L}_{2} = 3 {β}^{2} - \frac{\hat{B}}{\hat{J}} {L}_{1} = 3 {β}^{2} + 3 β \frac{\hat{B}}{\hat{J}} + {( \frac{\hat{B}}{\hat{J}} )}^{2}$$
$${L}_{3} = {β}^{3} \hat{J} .$$

8. The system of claim 3, wherein the operation unit comprises:
a first multiplier configured to multiply the output of the second gain unit and a moment of inertia of the motor, and provide an output;
an operator configured to add the output of the first multiplier and an output torque of the motor, to subtract the output of the second multiplier from a result of the addition, and output a result of the subtraction;
a second multiplier configured to multiply the output of the operator and an inverse number of a moment of inertia of the motor, and provide an output;
a third integrator configured to estimate a rotor velocity in the rotor information by integrating the output of the second multiplier, and provide an output; and
a third multiplier configured to multiply the output of the third integrator and a coefficient of friction of the motor, and output a result of the multiplication to the operator.

9. The system of claim 8, wherein the operator is configured to subtract the output of the third multiplier and output a result of the subtraction to the second multiplier.

10. The system of claim 3, wherein the addition unit is configured to add the output of the first gain unit and output a result of the addition to the first integrator.

11. The system of claim 9, wherein the second integrator is configured to integrate the output of the third gain unit and output a result of the integration to the operator.

12. The system of claim 2, wherein the error calculator comprises:
a first multiplier operator configured to multiply a cosine signal of the output of the first integrator and a sine signal of the rotor location measured by the resolver, and provide an output;
a second multiplier operator configured to multiply a sine signal of the output of the first integrator and a cosine signal of the rotor location measured by the resolver, and provide an output; and
a subtractor configured to subtract the output of the second multiplier operator from the output of the first multiplier operator and output a result of the subtraction to the gain unit.

13. The system of claim 1, wherein the motor is a permanent magnet synchronous motor.

14. The system of claim 13, wherein a machine model of the motor is expressed according to an equation,
$${T}_{e} = J \frac{d {ω}_{rm}}{d t} + B {ω}_{rm} + {T}_{L}$$
where Tₑ denotes an output torque of the motor, J denotes a moment of inertia of the motor, ωᵣₘ denotes an angular velocity, B denotes a coefficient of friction, and T_{L} denotes a load torque.

15. The system of claim 14, wherein the proportional-integral observer is modeled according to an equation,
$$\dot{x} = Ax + Bu$$
$$y = Cx$$
$$\frac{d}{d t} [ \begin{matrix}{θ}_{rm} \\ {ω}_{rm} \\ {\hat{T}}_{L}\end{matrix} ] = [ \begin{matrix}0 & 1 & 0 \\ 0 & - \frac{{B}_{mot}}{{J}_{mot}} & - \frac{1}{{J}_{mot}} \\ 0 & 0 & 0\end{matrix} ] [ \begin{matrix}{θ}_{rm} \\ {ω}_{rm} \\ {\hat{T}}_{L}\end{matrix} ] + [ \begin{matrix}0 \\ \frac{1}{{J}_{mot}} \\ 0\end{matrix} ] {T}_{e}^{*}$$
$$y = [ \begin{matrix}1 & 0 & 0 ]\end{matrix} [ \begin{matrix}{θ}_{rm} \\ {ω}_{rm} \\ {\hat{T}}_{L}\end{matrix} ] = {θ}_{rm}$$
where θᵣₘ denotes a rotor location, ωᵣₘ denotes a rotor velocity that is the angular velocity, \hat{T}_{L} denotes a load torque of the motor, Bₘₒₜ denotes a coefficient of friction of the motor, and Jₘₒₜ denotes a moment of inertia of the motor.

16. The system of claim 15, wherein the proportional-integral observer is modeled according to an equation,
$$\dot{\hat{x}} = \hat{A} \hat{x} + \hat{B} u + L ( y - C \hat{x} ) \\ \frac{d}{d t} [ \begin{matrix}{\hat{θ}}_{rm} \\ {\hat{ω}}_{rm} \\ {\hat{T}}_{L}\end{matrix} ] = [ \begin{matrix}0 & 1 & 0 \\ 0 & - \frac{\hat{B}}{\hat{J}} & - \frac{1}{\hat{J}} \\ 0 & 0 & 0\end{matrix} ] [ \begin{matrix}{\hat{θ}}_{rm} \\ {\hat{ω}}_{rm} \\ {\hat{T}}_{L}\end{matrix} ] + [ \begin{matrix}0 \\ \frac{1}{\hat{J}} \\ 0\end{matrix} ] {T}_{e}^{*} + [ \begin{matrix}{L}_{1} \\ {L}_{2} \\ {L}_{3}\end{matrix} ] ( {θ}_{rm} - \begin{matrix}[ 1 & 0 & 0 ]\end{matrix} [ \begin{matrix}{\hat{θ}}_{rm} \\ {\hat{ω}}_{rm} \\ {\hat{T}}_{L}\end{matrix} ] )$$
where \hat{θ}ᵣₘ denotes an estimated rotor location, \hat{ω}ᵣₘ denotes an estimated rotor velocity, \hat{T}_{L} denotes an estimated load torque, \hat{θ}ᵣₘ denotes a resolver output that is the rotor location, \hat{B} denotes the coefficient of friction of the motor, Ĵ denotes the moment of inertia of the motor, T*ₑ denotes an output torque of the motor, L₁ denotes a first gain, L₂ denotes a second gain, and L₃ denotes a third gain.
